(19) United States
(12) Patent Application Publication
(10) Pub. No.: US 2014/0015360 A1
(43) Pub. Date: Jan. 16, 2014

(54) MOTOR STRUCTURE

(71) Applicant: Jin Seok Kim, Suwon (KR)

(72) Inventor: Jin Seok Kim, Suwon (KR)

(21) Appl. No.: 13/923,057

(22) Filed: Jun. 20, 2013

(30) Foreign Application Priority Data
Jul. 10, 2012 (KR) 10-2012-0074928

(51) Int. Cl. H02K 5/16

(52) U.S. Cl. CPC H02K 5/161
USPC 310/90

(57) ABSTRACT

Disclosed herein is a motor structure including a case provided with a predetermined inner space defined by coupling of a front housing and a rear housing, a rotor arranged within the case and provided with a circular yoke to which a plurality of magnets is mounted, a rotating shaft having a predetermined length and coupled to a center of the rotor, one end of the rotating shaft penetrating the front housing and the other end of the rotating shaft provided with a hole formed in a longitudinal direction of the rotating shaft, a stator spaced a distance apart from the rotor and provided with a coil wound therearound and surrounding the rotor, and a support arranged at the rear housing and inserted into the hole of the rotating shaft to support the rotating shaft to allow the rotating shaft to rotate.

### CROSS-REFERENCE TO RELATED APPLICATION(S)

This application claims the benefit of Korean Patent Application No. 2012-0074928, filed on Jul. 10, 2012 in the Korean Intellectual Property Office, the disclosure of which is incorporated herein by reference.

### BACKGROUND

1. Field

Embodiments of the present invention relate to a motor structure that may reduce the length of a motor and lower noise from the motor.

2. Description of the Related Art

In general, a motor is a commonly known technology that is used in various fields as a device producing rotational force from electric power applied thereto.

FIG. 1 illustrates a conventional motor structure. With reference to FIG. 1, the motor structure 1 includes a case 10, a rotor 20 arranged in the case 10 and having a plurality of magnets 24 mounted to a circular yoke and a rotating shaft 30 coupled at the center thereof, and a stator 40 to generate rotational driving force for the rotor 20.

Such a motor structure 1 is provided with ball bearings 31 and 32 mounted between the rotating shaft 30 and the case 10 to support the rotating shaft 30 and to allow the rotating shaft 30 to rotate. The ball bearings 31 and 32 are respectively installed on the front side and rear side of the rotating shaft 30 to stably support the rotating shaft 30.

As shown in FIG. 1, the rear side of the rotating shaft 30 protrudes to be coupled with the ball bearing 32. Since a space to support the rotating shaft 30 may be needed depending on how the rotating shaft 30 is coupled with the ball bearing, the motor structure 1 might be unnecessarily elongated.

Further, rotation of the rotating shaft 30 may cause not only vibration of the ball bearing 32, but also noise resulting from the vibration.

### SUMMARY

Therefore, it is an aspect of the present invention to provide a motor structure which may have a reduced length and decrease vibration and noise occurring during operation of a motor.

Additional aspects of the invention will be set forth in part in the description which follows and, in part, will be obvious from the description, or may be learned by practice of the invention.

In accordance with one aspect of the present invention, a motor structure to provide rotational force may include a case provided with a predetermined inner space defined by coupling of a front housing and a rear housing, a rotor arranged within the case and provided with a circular yoke to which a plurality of magnets is mounted, a rotating shaft having a predetermined length and coupled to a center of the rotor, one end of the rotating shaft penetrating the front housing and the other end of the rotating shaft provided with a hole formed in a longitudinal direction of the rotating shaft, a stator spaced a distance apart from the rotor and provided with a coil wound therearound and surrounding the rotor, and a support arranged at the rear housing and inserted into the hole of the rotating shaft to support the rotating shaft to allow the rotating shaft to rotate.

A friction reducing member may be arranged between the support and the hole of the rotating shaft to reduce noise in rotation of the rotating shaft.

The friction reducing member may be formed of a solid lubricant containing Teflon or a plate coated with a solid lubricant.

The friction reducing member may be formed in a flange shape or a sleeve shape and be press-fitted into the hole.

The support may be formed in a pin shape and integrated with the rear housing.

The support may be formed in steel press technique to improve surface roughness thereof.

Further, a bearing may be installed between the rotating shaft and the front housing to support the rotating shaft and to allow the rotating shaft to rotate.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a cross-sectional view schematically illustrating a conventional motor structure; and

FIG. 2 is a cross-sectional view illustrating a motor structure according to an exemplary embodiment of the present invention.

### DETAILED DESCRIPTION

Reference will now be made in detail to the embodiments of the present invention, examples of which are illustrated in the accompanying drawings, wherein like reference numerals refer to like elements throughout.

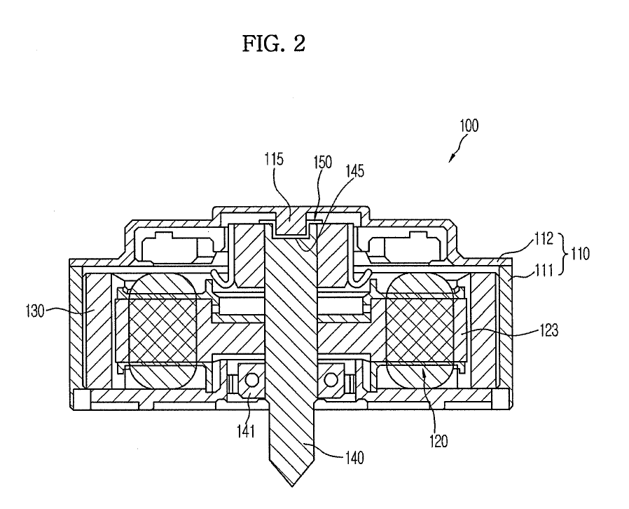

FIG. 2 is a cross-sectional view illustrating a motor structure according to an exemplary embodiment of the present invention.

With reference to FIG. 2, a motor structure 100 includes a case 110, a rotor 120 arranged within the case 110 and provided with a rotating shaft 140 installed at the center of the rotor 120, a stator 130 to generate rotational driving force for the rotor 120, and a support 115 to support the rotating shaft 140.

The case 110 is formed by coupling of a front housing 111 and a rear housing 112 to define a predetermined space therein. The front housing 111 is arranged with one side thereof open, and the rear housing 112 is coupled with the front housing 111 to close the open one side of the front housing 111. The rear housing 112 is provided with the support 115 to be inserted into a hole 145 formed in the rotating shaft 140, which will be described below. The support 115 will be described later in the present application.

Arranged within the case 110 is the rotor 120 provided with a circular yoke to which a plurality of magnets 123 is mounted, and the stator 130 disposed to face the rotor 120. The stator 130 is installed on the inner side surface of the front housing 111 to surround the rotor 120 at a distance apart from the rotor 120 and is provided with a coil wound therearound (not shown). Thereby, when electric power is applied to the coil, repulsive force and attractive force are created between the magnets 123 and the coil to rotate the rotor 120.

The rotating shaft 140 is coupled to the center of the rotor 120 to rotate together with the rotor 120. The rotating shaft 140 has a predetermined length, one end thereof penetrates the front housing 111 and protrudes outside the case 110, and the other end thereof is arranged within the case 110 to be positioned close to the rear housing 112. A hole 145 is formed at the center of the other end of the rotating shaft 140 in the longitudinal direction of the rotating shaft 140. The hole 145 is provided so that the support 115 described above is inserted into the hole 145 and the rotating shaft 140 is rotatably supported by the support 115. That is, the rotating shaft 140 is supported by the support 115 inserted into the hole 145.

According to the illustrated embodiment of the present invention, a friction reducing member 150 is further provided between the hole 145 of the rotating shaft 140 and the support 115 to reduce noise in rotation of the rotating shaft 140. The friction reducing member 150 is press-fit into the hole 145, and may be formed to have a shape of a sleeve with a center penetrated to allow the support 115 to be inserted into the friction reducing member 150 or have a shape of a flange to surround the hole 145 and the periphery of the hole 145 as shown in FIG. 2. The friction reducing member 150 may be formed of a solid lubricant containing Teflon or a plate coated with a solid lubricant to minimize friction between the rotating shaft 140 and the support 115 to allow the rotating shaft 140 to smoothly rotate.

The support 115 inserted into the friction reducing member 150 may be formed in a pin shape and integrated with the rear housing 112. Here, the support 115 is made by steel press technique in manufacturing the rear housing 112 to improve roughness of the surface of support 115 contacting the friction reducing member 150 coupled with the support 115. Thereby, the inconvenience of separately installing the support 115 at the rear housing 112 may be eliminated. Further, as the roughness of the surface is improved, not only may noise created by rotation of the rotating shaft 140 be reduced, but also performance of the motor structure may be improved.

Meanwhile, reference numeral ‘141’ indicates a bearing installed between the rotating shaft 140 and the front housing 111 to support the rotating shaft 140 to further ensure that the rotating shaft 140 is stably rotatable.

As described above, the hole 145 is formed at the other end of the rotating shaft 140, and the support 115 inserted into the hole 145 is integrated with the case 110. Thereby, the length of the case 110 may be reduced compared to conventional cases.

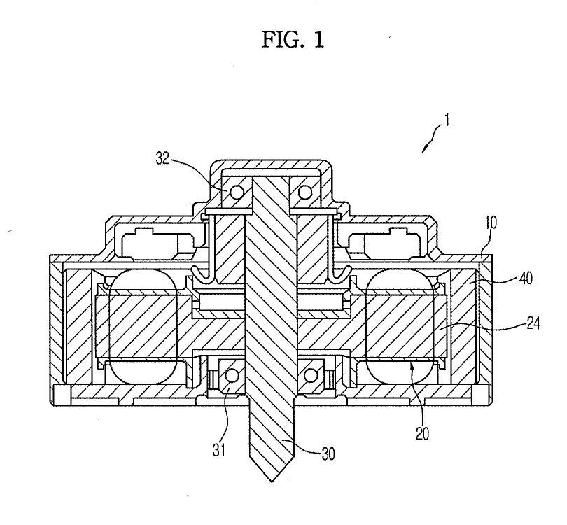

Further, as the ball bearing (see ‘32’ in FIG. 1) to support the rotating shaft (see ‘30’ in FIG. 1) is eliminated, vibration and noise occurring during operation of the motor may be lowered.

As is apparent from the above description, a motor structure according to embodiments of the present invention may have a reduced length as a hole is formed in a rotating shaft and a support to be inserted into the hole is provided at the case, and thereby the space for coupling between the bearings to support the rotating shaft and the rotating shaft is reduced, compared to conventional cases.

Further, as the conventional ball bearing to support the rotating shaft is eliminated, vibration and noise incurred in operation of the motor may be reduced.

In addition, as steel press technique is used to integrate the support with case, the need for separate assembly of the support may be eliminated and the surface roughness of the support may be improved, and thus the motor structure may be improved in terms of noise and performance.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A motor structure to provide rotational force, comprising:
a case provided with a predetermined inner space defined by coupling of a front housing and a rear housing;
a rotor arranged within the case and provided with a circular yoke to which a plurality of magnets is mounted;
a rotating shaft having a predetermined length and coupled to a center of the rotor, one end of the rotating shaft penetrating the front housing and the other end of the rotating shaft provided with a hole formed in a longitudinal direction of the rotating shaft;
a stator spaced a distance apart from the rotor and provided with a coil wound therearound and surrounding the rotor; and
a support arranged at the rear housing and inserted into the hole of the rotating shaft to support the rotating shaft to allow the rotating shaft to rotate.

2. The motor structure according to claim 1, wherein a friction reducing member is arranged between the support and the hole of the rotating shaft to reduce noise during rotation of the rotating shaft.

3. The motor structure according to claim 2, wherein the friction reducing member is formed of a solid lubricant containing Teflon or a plate coated with a solid lubricant.

4. The motor structure according to claim 3, wherein the friction reducing member is formed in a flange shape or a sleeve shape and is press-fitted into the hole.

5. The motor structure according to claim 1, wherein the support is formed in a pin shape and integrated with the rear housing.

6. The motor structure according to claim 5, wherein the support is formed in steel press technique to improve surface roughness thereof.

7. The motor structure according to claim 1, wherein a bearing is installed between the rotating shaft and the front housing to support the rotating shaft and to allow the rotating shaft to rotate.
